(19) United States
(12) Patent Application Publication
(10) Pub. No.: US 2010/0144420 A1
(43) Pub. Date: Jun. 10, 2010

(54) MOVING INDICATOR

(75) Inventor: Richard W. Fiore, Las Vegas, NV (US)

Correspondence Address: MARGER JOHNSON & MCCOLLOM, P.C., 210 SW MORRISON STREET, SUITE 400, PORTLAND, OR, 97204, US

(73) Assignee: ACRES-FIORE, INC., Las Vegas, NV (US)

(21) Appl. No.: 12/331,276

(22) Filed: Dec. 9, 2008

(51) Int. Cl. A63F 9/24; A63F 13/00

(52) U.S. Cl. 463/20

(57) ABSTRACT

Embodiments of the present invention are directed to a moving indicator that is positionable over individual gaming devices in a bank of gaming devices. The moving indicator includes a moveable platform and a moving unit for positioning the moveable platform above the individual gaming devices. The moving indicator includes a display and a plurality of selectable features. The display and selectable features can be selectively activated in response to events on the individual gaming devices.

### FIELD OF THE INVENTION

This disclosure relates generally to gaming devices, and more particularly to a moving indicator for a bank of gaming devices.

### BACKGROUND

Gaming is a popular activity for persons of all ages. Popular games include both automated games, in which a player plays against a machine, such as slots, poker, bingo, etc., as well as those games in which a player plays against live individuals such as a dealer or other players. Gaming is enjoyed both by players who view the experience as entertainment, as well as those who pursue gaming for financial gain.

Part of the allure of casino gaming is the many lights and sounds associated with the casino environment. Because it may not be appropriate to watch gaming sessions in progress over a player's shoulder, many casinos have overhead displays that notify people in the casino of recent wins, the value of upcoming jackpots, etc. However, these overhead displays are not necessarily associated with any particular gaming device or bank of gaming devices. Consequently, these overhead displays do not necessarily provide the type of real-time, gaming-device-specific information that potential players desire.

### BRIEF DESCRIPTION OF THE DRAWINGS

FIG. 1A is a functional block diagram that illustrates a gaming device according to embodiments of the invention.

FIG. 1B is an isometric view of the gaming device illustrated in FIG. 1A.

FIGS. 2A, 2B, and 2C are detail diagrams of exemplary types of gaming devices according to embodiments of the invention.

FIG. 3 is a functional block diagram of networked gaming devices according to embodiments of the invention.

FIG. 4 is a front view of a moving indicator positioned above a bank of gaming devices.

FIG. 5 is a side view of the moving indicator.

FIG. 6 is a top view of the moving indicator.

FIG. 7 is a schematic view of the moving indicator illustrating various components.

FIG. 8 is a flowchart of a method of operating a moving indicator.

FIG. 9 is a flowchart of a method of conducting a game of chance.

### DETAILED DESCRIPTION

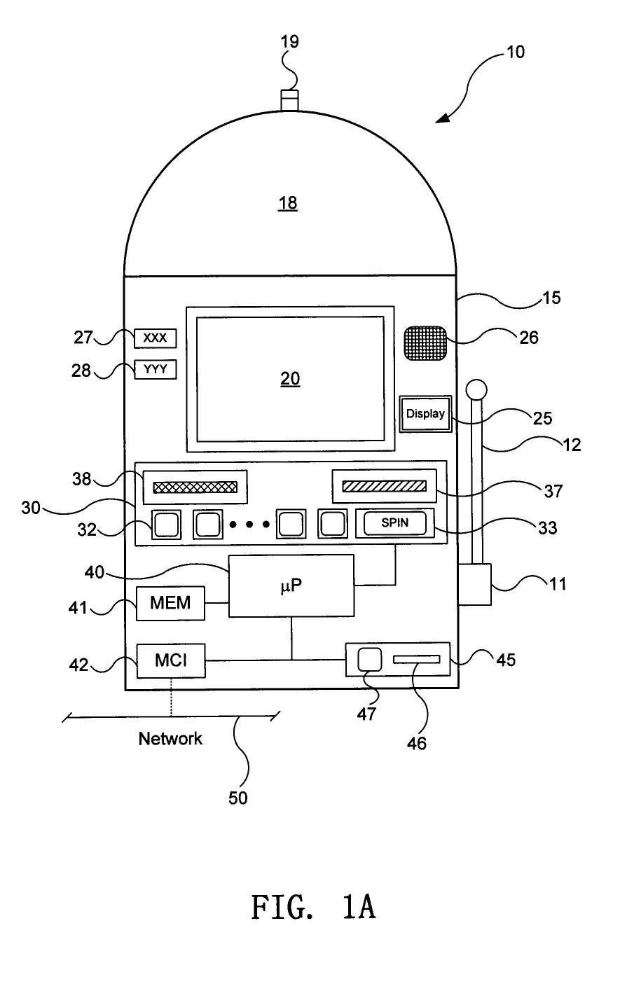

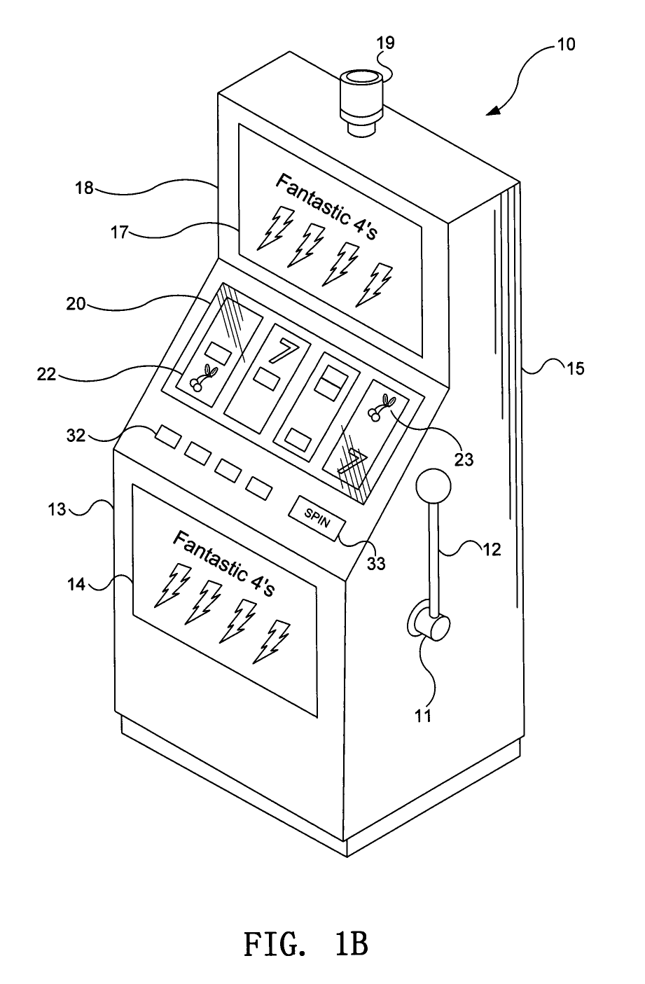

FIGS. 1A and 1B illustrate example gaming devices according to embodiments of the invention.

Referring to FIGS. 1A and 1B, a gaming device 10 is an electronic gaming machine. Although an electronic gaming machine or “slot” machine is illustrated, various other types of devices may be used to wager monetarily based credits on a game of chance in accordance with principles of the invention. The term “electronic gaming device” is meant to include various devices such as electro-mechanical spinning-reel type slot machines, video slot machines, and video poker machines, for instance. Other gaming devices may include computer-based gaming machines, wireless gaming devices, multi-player gaming stations, modified personal electronic gaming devices (such as cell phones), personal computers, server-based gaming terminals, and other similar devices. Although embodiments of the invention will work with all of the gaming types mentioned, for ease of illustration the present embodiments will be described in reference to the electronic gaming machine 10 shown in FIGS. 1A and 1B.

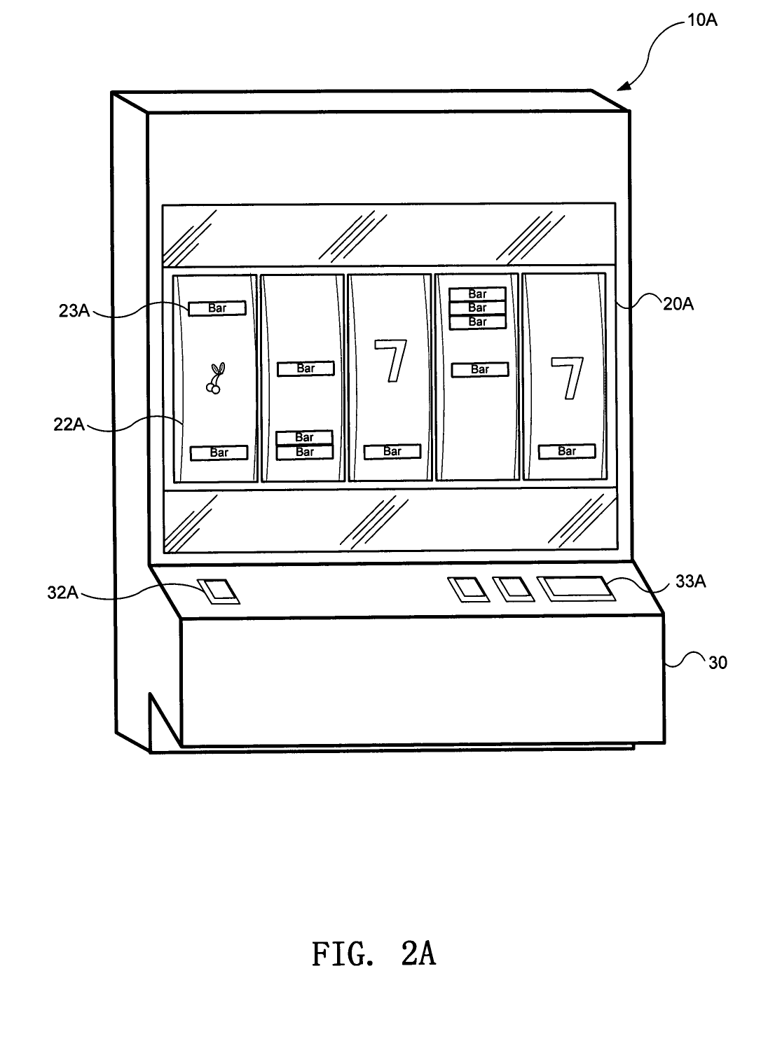

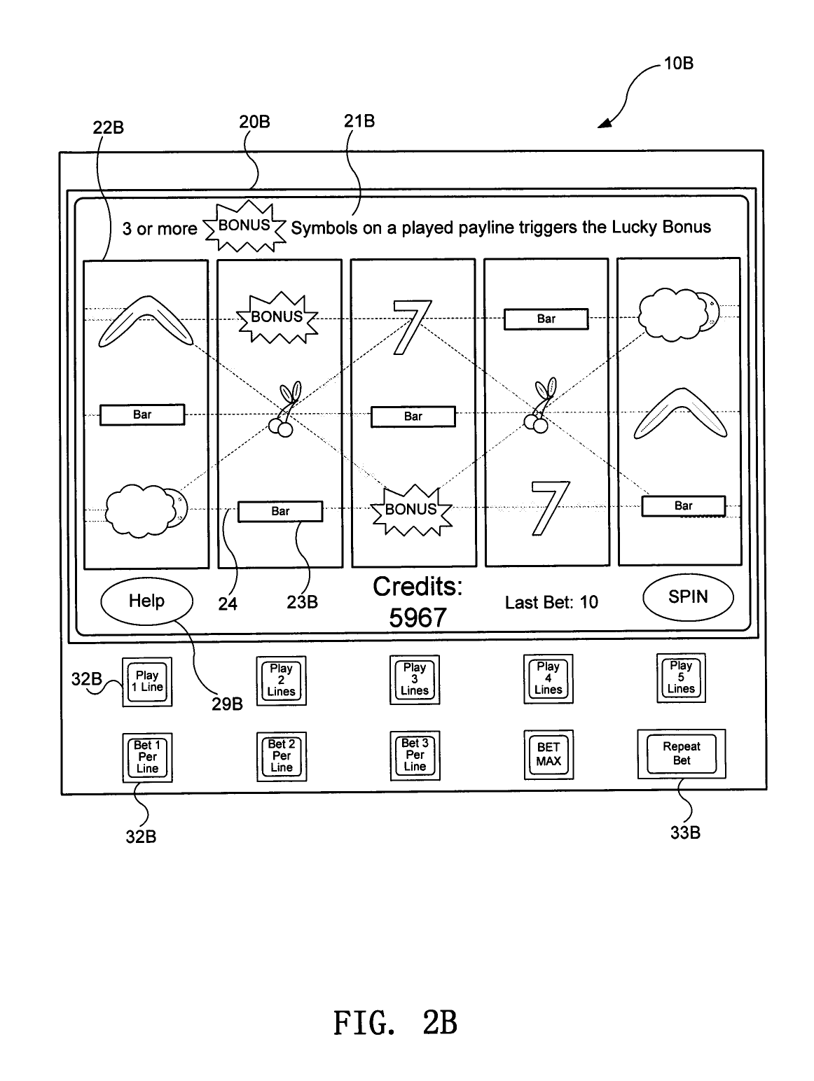

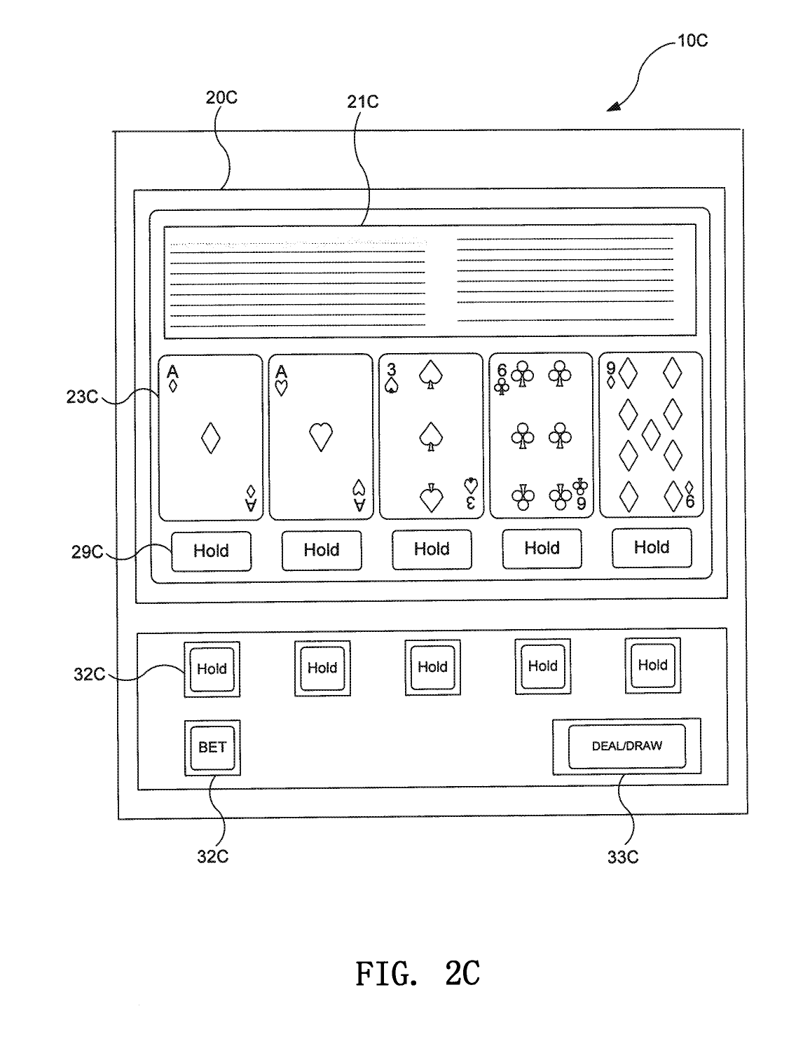

The gaming device 10 includes a cabinet 15 housing components to operate the gaming device 10. The cabinet 15 may include a gaming display 20, a base portion 13, a top box 18, and a player interface panel 30. The gaming display 20 may include mechanical spinning reels (FIG. 2A), a video display (FIGS. 2B and 2C), or a combination of both spinning reels and a video display (not shown). The gaming cabinet 15 may also include a credit meter 27 and a coin-in or bet meter 28. The credit meter 27 may indicate the total number of credits remaining on the gaming device 10 that are eligible to be wagered. In some embodiments, the credit meter 27 may reflect a monetary unit, such as dollars. However, it is often preferable to have the credit meter 27 reflect a number of ‘credits,’ rather than a monetary unit. The bet meter 28 may indicate the amount of credits to be wagered on a particular game. Thus, for each game, the player transfers the amount that he or she wants to wager from the credit meter 27 to the bet meter 28. In some embodiments, various other meters may be present, such as meters reflecting amounts won, amounts paid, or the like. In embodiments where the gaming display 20 is a video monitor, the information indicated on the credit meters may be shown on the gaming display 20 (FIG. 2B).

The base portion 13 may include a lighted panel 14, a coin return (not shown), and a gaming handle 12 operable on a partially rotating pivot joint 11. The game handle 12 is traditionally included on mechanical spinning-reel games, where the handle may be pulled toward a player to initiate the spinning of reels 22 after placement of a wager. The top box 18 may include a lighted panel 17, a video display (such as an LCD monitor), a mechanical bonus device (not shown), and a candle light indicator 19. The player interface panel 30 may include various devices so that a player can interact with the gaming device 10.

The player interface panel 30 may include one or more game buttons 32 that can be actuated by the player to cause the gaming device 10 to perform a specific action. For example, some of the game buttons 32 may cause the gaming device 10 to bet a credit to be wagered during the next game, change the number of lines being played on a multi-line game, cash out the credits remaining on the gaming device (as indicated on the credit meter 27), or request assistance from casino personnel, such as by lighting the candle 19. In addition, the player interface panel 30 may include one or more game actuating buttons 33. The game actuating buttons 33 may initiate a game with a pre-specified amount of credits. On some gaming devices 10 a “Max Bet” game actuating button 33 may be included that places the maximum credit wager on a game and initiates the game. The player interface panel 30 may further include a bill acceptor 37 and a ticket printer 38. The bill acceptor 37 may accept and validate paper money or previously printed tickets with a credit balance. The ticket printer 38 may print out tickets reflecting the balance of the credits that remain on the gaming device 10 when a player cashes out by pressing one of the game buttons 32 programmed to cause a ‘cashout.’ These tickets may be inserted into other gaming machines or redeemed at a cashier station or kiosk for cash.

The gaming device 10 may also include one or more speakers 26 to transmit auditory information or sounds to the player. The auditory information may include specific sounds associated with particular events that occur during game play on the gaming device 10. For example, a particularly festive sound may be played during a large win or when a bonus is triggered. The speakers 26 may also transmit “attract” sounds to entice nearby players when the game is not currently being played.

The gaming device 10 may further include a secondary display 25. This secondary display 25 may be a vacuum fluorescent display (VFD), a liquid crystal display (LCD), a cathode ray tube (CRT), a plasma screen, or the like. The secondary display 25 may show any combination of primary game information and ancillary information to the player. For example, the secondary display 25 may show player tracking information, secondary bonus information, advertisements, or player selectable game options.

The gaming device 10 may include a separate information window (not shown) dedicated to supplying any combination of information related to primary game play, secondary bonus information, player tracking information, secondary bonus information, advertisements or player selectable game options. This window may be fixed in size and location or may have its size and location vary temporally as communication needs change. One example of such a resizable window is International Game Technology's “service window”. Another example is Las Vegas Gaming Incorporated's retrofit technology which allows information to be placed over areas of the game or the secondary display screen at various times and in various situations.

The gaming device 10 includes a microprocessor 40 that controls operation of the gaming device 10. If the gaming device 10 is a standalone gaming device, the microprocessor 40 may control virtually all of the operations of the gaming devices and attached equipment, such as operating game logic stored in memory (not shown) as firmware, controlling the display 20 to represent the outcome of a game, communicating with the other peripheral devices (such as the bill acceptor 37), and orchestrating the lighting and sound emanating from the gaming device 10. In other embodiments where the gaming device 10 is coupled to a network 50, as described below, the microprocessor 40 may have different tasks depending on the setup and function of the gaming device. For example, the microprocessor 40 may be responsible for running the base game of the gaming device and executing instructions received over the network 50 from a bonus server or player tracking server. In a server-based gaming setup, the microprocessor 40 may act as a terminal to execute instructions from a remote server that is running game play on the gaming device.

The microprocessor 40 may be coupled to a machine communication interface (MCI) 42 that connects the gaming device 10 to a gaming network 50. The MCI 42 may be coupled to the microprocessor 40 through a serial connection, a parallel connection, an optical connection, or in some cases a wireless connection. The gaming device 10 may include memory 41 (MEM), such as a random access memory (RAM), coupled to the microprocessor 40 and which can be used to store gaming information, such as storing total coin-in statistics about a present or past gaming session, which can be communicated to a remote server or database through the MCI 42. The MCI 42 may also facilitate communication between the network 50 and the secondary display 25 or a player tracking unit 45 housed in the gaming cabinet 15.

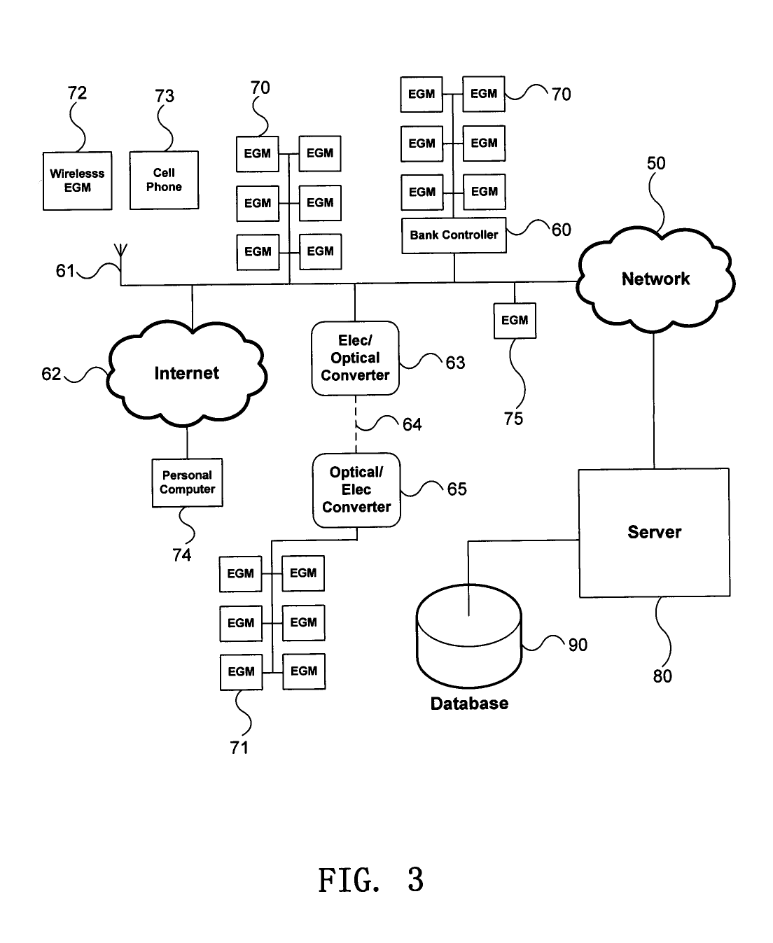

The player tracking unit 45 may include an identification device 46 and one or more buttons 47 associated with the player tracking unit 45. The identification device 46 serves to identify a player, by, for example, reading a player-tracking device, such as a player tracking card that is issued by the casino to individual players who choose to have such a card. The identification device 46 may instead, or additionally, identify players through other methods. Player tracking systems using player tracking cards and card readers 46 are known in the art. Briefly summarizing such a system, a player registers with the casino prior to commencing gaming. The casino issues a unique player-tracking card to the player and opens a corresponding player account that is stored on a server or host computer, described below with reference to FIG. 3. The player account may include the player's name and mailing address and other information of interest to the casino in connection with marketing efforts. Prior to playing one of the gaming devices in the casino, the player inserts the player tracking card into the identification device 46 thus permitting the casino to track player activity, such as amounts wagered, credits won, and rate of play.

To induce the player to use the card and be an identified player, the casino may award each player points proportional to the money or credits wagered by the player. Players typically accrue points at a rate related to the amount wagered, although other factors may cause the casino to award the player various amounts. The points may be displayed on the secondary display 25 or using other methods. In conventional player tracking systems, the player may take his or her card to a special desk in the casino where a casino employee scans the card to determine how many accrued points are in the player's account. The player may redeem points for selected merchandise, meals in casino restaurants, or the like, which each have assigned point values. In some player tracking systems, the player may use the secondary display 25 to access their player tracking account, such as to check a total number of points, redeem points for various services, make changes to their account, or download promotional credits to the gaming device 10. In other embodiments, the identification device 46 may read other identifying cards (such as driver licenses, credit cards, etc.) to identify a player and match them to a corresponding player tracking account. Although FIG. 1A shows the player tracking unit 45 with a card reader as the identification device 46, other embodiments may include a player tracking unit 45 with a biometric scanner, PIN code acceptor, or other methods of identifying a player to pair the player with their player tracking account.

During typical play on a gaming device 10, a player plays a game by placing a wager and then initiating a gaming session. The player may initially insert monetary bills or previously printed tickets with a credit value into the bill acceptor 37. The player may also put coins into a coin acceptor (not shown) or a credit, debit or casino account card into a card reader/authorizer (not shown). One of skill in the art will readily see that this invention is useful with all gambling devices, regardless of the manner in which wager value-input is accomplished.

The credit meter 27 displays the numeric credit value of the money inserted dependent on the denomination of the gaming device 10. That is, if the gaming device 10 is a nickel slot machine and a $20 bill inserted into the bill acceptor 37, the credit meter will reflect 400 credits or one credit for each nickel of the inserted twenty dollars. For gaming devices 10 that support multiple denominations, the credit meter 27 will reflect the amount of credits relative to the denomination selected. Thus, in the above example, if a penny denomination is selected after the $20 is inserted the credit meter will change from 400 credits to 2000 credits.

A wager may be placed by pushing one or more of the game buttons 32, which may be reflected on the bet meter 28. That is, the player can generally depress a “bet one” button (one of the buttons on the player interface panel 30, such as 32), which transfers one credit from the credit meter 27 to the bet meter 28. Each time the button 32 is depressed an additional single credit transfers to the bet meter 28 up to a maximum bet that can be placed on a single play of the electronic gaming device 10. The gaming session may be initiated by pulling the gaming handle 12 or depressing the spin button 33. On some gaming devices 10, a “max bet” button (another one of the buttons 32 on the player interface panel 30) may be depressed to wager the maximum number of credits supported by the gaming device 10 and initiate a gaming session.

If the gaming session does not result in any winning combination, the process of placing a wager may be repeated by the player. Alternatively, the player may cash out any remaining credits on the credit meter 27 by depressing the “cash-out” button (another button 32 on the player interface panel 30), which causes the credits on the credit meter 27 to be paid out in the form of a ticket through the ticket printer 38, or may be paid out in the form of returning coins from a coin hopper (not shown) to a coin return tray.

If instead a winning combination (win) appears on the display 20, the award corresponding to the winning combination is immediately applied to the credit meter 27. For example, if the gaming device 10 is a slot machine, a winning combination of symbols 23 may land on a played payline on reels 22. If any bonus games are initiated, the gaming device 10 may enter into a bonus mode or simply award the player with a bonus amount of credits that are applied to the credit meter 27.

FIGS. 2A to 2C illustrate exemplary types of gaming devices according to embodiments of the invention. FIG. 2A illustrates an example spinning-reel gaming machine 10A, FIG. 2B illustrates an example video slot machine 10B, and FIG. 2C illustrates an example video poker machine 10C.

Referring to FIG. 2A, a spinning-reel gaming machine 10A includes a gaming display 20A having a plurality of mechanical spinning reels 22A. Typically, spinning-reel gaming machines 10A have three to five spinning reels 22A. Each of the spinning reels 22A has multiple symbols 23A that may be separated by blank areas on the spinning reels 22A, although the presence of blank areas typically depends on the number of reels 22A present in the gaming device 10A and the number of different symbols 23A that may appear on the spinning reels 22A. Each of the symbols 22A or blank areas makes up a “stop” on the spinning reel 22A where the reel 22A comes to rest after a spin. Although the spinning reels 22A of various games 10A may have various numbers of stops, many conventional spinning-reel gaming devices 10A have reels 22A with twenty two stops.

During game play, the spinning reels 22A may be controlled by stepper motors (not shown) under the direction of the microprocessor 40 (FIG. 1A). Thus, although the spinning-reel gaming device 10A has mechanical based spinning reels 22A, the movement of the reels themselves is electronically controlled to spin and stop. This electronic control is advantageous because it allows a virtual reel strip to be stored in the memory 41 of the gaming device 10A, where various “virtual stops” are mapped to each physical stop on the physical reel 22A. This mapping allows the gaming device 10A to establish greater awards and bonuses available to the player because of the increased number of possible combinations afforded by the virtual reel strips.

A gaming session on a spinning reel slot machine 10A typically includes the player pressing the “bet-one” button (one of the game buttons 32A) to wager a desired number of credits followed by pulling the gaming handle 12 (FIGS. 1A, 1B) or pressing the spin button 33A to spin the reels 22A. Alternatively, the player may simply press the “max-bet” button (another one of the game buttons 32A) to both wager the maximum number of credits permitted and initiate the spinning of the reels 22A. The spinning reels 22A may all stop at the same time or may individually stop one after another (typically from left to right) to build player anticipation. Because the display 20A usually cannot be physically modified, some spinning reel slot machines 10A include an electronic display screen in the top box 18 (FIG. 1B), a mechanical bonus mechanism in the top box 18, or a secondary display 25 (FIG. 1A) to execute a bonus.

Referring to FIG. 2B, a video gaming machine 10B may include a video display 20B to display virtual spinning reels 22B and various other gaming information 21B. The video display 20B may be a CRT, LCD, plasma screen, or the like. It is usually preferable that the video display 20B be a touchscreen to accept player input. A number of symbols 23A appear on each of the virtual spinning reels 22B. Although FIG. 2B shows five virtual spinning reels 22B, the flexibility of the video display 20B allows for various reel 22B and game configurations. For example, some video slot games 10B spin reels for each individual symbol position (or stop) that appears on the video display 20B. That is, each symbol position on the screen is independent of every other position during the gaming sessions. In these types of games, very large numbers of pay lines or multiple super scatter pays can be utilized since similar symbols could appear at every symbol position on the video display 20B. On the other hand, other video slot games 10B more closely resemble the mechanical spinning reel games where symbols that are vertically adjacent to each other are part of the same continuous virtual spinning reel 22B.

Because the virtual spinning reels 22B, by virtue of being computer implemented, can have almost any number of stops on a reel strip, it is much easier to have a greater variety of displayed outcomes as compared to spinning-reel slot machines 10A (FIG. 2A) that have a fixed number of physical stops on each spinning reel 22A.

With the possible increases in reel 22B numbers and configurations over the mechanical gaming device 10A, video gaming devices 10B often have multiple paylines 24 that may be played. By having more paylines 24 available to play, the player may be more likely to have a winning combination when the reels 22B stop and the gaming session ends. However, since the player typically must wager at least a minimum number of credits to enable each payline 24 to be eligible for winning, the overall odds of winning are not much different, if at all, than if the player is wagering only on a single payline. For example, in a five line game, the player may bet one credit per payline 24 and be eligible for winning symbol combinations that appear on any of the five played paylines 24. This gives a total of five credits wagered and five possible winning paylines 24. If, on the other hand, the player only wagers one credit on one payline 24, but plays five gaming sessions, the odds of winning would be identical as above: five credits wagered and five possible winning paylines 24.

Because the video display 20B can easily modify the image output by the video display 20B, bonuses, such as second screen bonuses are relatively easy to award on the video slot game 10B. That is, if a bonus is triggered during game play, the video display 20B may simply store the resulting screen shot in memory and display a bonus sequence on the video display 20B. After the bonus sequence is completed, the video display 20B may then retrieve the previous screen shot and information from memory, and re-display that image.

Also, as mentioned above, the video display 20B may allow various other game information 21B to be displayed. For example, as shown in FIG. 2B, banner information may be displayed above the spinning reels 22B to inform the player, perhaps, which symbol combination is needed to trigger a bonus. Also, instead of providing a separate credit meter 27 (FIG. 1A) and bet meter 28, the same information can instead be displayed on the video display 20B. In addition, “soft buttons” 29B such as a “spin” button or “help/see pays” button may be built using the touch screen video display 20B. Such customization and ease of changing the image shown on the display 20B adds to the flexibility of the game 10B.

Even with the improved flexibility afforded by the video display 20B, several physical buttons 32B and 33B are usually provided on video slot machines 10B. These buttons may include game buttons 32B that allow a player to choose the number of paylines 24 he or she would like to play and the number of credits wagered on each payline 24. In addition, a max bet button (one of the game buttons 32B) allows a player to place a maximum credit wager on the maximum number of available paylines 24 and initiate a gaming session. A repeat bet or spin button 33B may also be used to initiate each gaming session when the max bet button is not used.

Referring to FIG. 2C, a video poker gaming device 10C may include a video display 20C that is physically similar to the video display 20B shown in FIG. 2B. The video display 20C may show a poker hand of five cards 23C and various other player information 21C including a paytable for various winning hands, as well as a plurality of player selectable soft buttons 29C. The video display 20C may present a poker hand of five cards 23C and various other player information 21C including a number of player selectable soft (touch-screen) buttons 29C and a paytable for various winning hands. Although the embodiment illustrated in FIG. 3C shows only one hand of poker on the video display 20C, various other video poker machines 10C may show several poker hands (multi-hand poker). Typically, video poker machines 10C play “draw” poker in which a player is dealt a hand of five cards, has the opportunity to hold any combination of those five cards, and then draws new cards to replace the discarded ones. All pays are usually given for winning combinations resulting from the final hand, although some video poker games 10C may give bonus credits for certain combinations received on the first hand before the draw. In the example shown in FIG. 2C a player has been dealt two aces, a three, a six, and a nine. The video poker game 10C may provide a bonus or payout for the player having been dealt the pair of aces, even before the player decides what to discard in the draw. Since pairs, three of a kind, etc. are typically needed for wins, a player would likely hold the two aces that have been dealt and draw three cards to replace the three, six, and nine in the hope of receiving additional aces or other cards leading to a winning combination with a higher award amount. After the draw and revealing of the final hand, the video poker game 10C typically awards any credits won to the credit meter.

The player selectable soft buttons 29C appearing on the screen respectively correspond to each card on the video display 20C. These soft buttons 29C allow players to select specific cards on the video display 20C such that the card corresponding to the selected soft button is “held” before the draw. Typically, video poker machines 10C also include physical game buttons 32C that correspond to the cards in the hand and may be selected to hold a corresponding card. A deal/draw button 33C may also be included to initiate a gaming session after credits have been wagered (with a bet button 32C, for example) and to draw any cards not held after the first hand is displayed.

Although examples of a spinning reel slot machine 10A, a video slot machine 10B, and a video poker machine 10C have been illustrated in FIGS. 2A-2C, gaming machines and various other types of gaming devices known in the art are contemplated and are within the scope of the invention.

FIG. 3 is a block diagram illustrating networked gaming devices according to embodiments of the invention. Referring to FIG. 3, multiple electronic gaming devices (EGMs) 70, 71, 72, 73, 74, and 75 may be coupled to one another and coupled to a remote server 80 through a network 50. For ease of understanding, gaming devices or EGMs 70, 71, 72, 73, 74, and 75 are generically referred to as EGMs 70-75. The term EGMs 70-75, however, may refer to any combination of one or more of EGMs 70, 71, 72, 73, 74, and 75. Additionally, the gaming server 80 may be coupled to one or more gaming databases 90. These gaming network 50 connections may allow multiple gaming devices 70-75 to remain in communication with one another during particular gaming modes such as tournament play or remote head-to-head play. Although some of the gaming devices 70-75 coupled on the gaming network 50 may resemble the gaming devices 10, 10A, 10B, and 10C shown in FIGS. 1A-1B and 2A-2C, other coupled gaming devices 70-75 may include differently configured gaming devices. For example, the gaming devices 70-75 may include traditional slot machines 75 directly coupled to the network 50, banks of gaming devices 70 coupled to the network 50, banks of gaming devices 70 coupled to the network through a bank controller 60, wireless handheld gaming machines 72 and cell phones 73 coupled to the gaming network 50 through one or more wireless routers or antennas 61, personal computers 74 coupled to the network 50 through the internet 62, and banks of gaming devices 71 coupled to the network through one or more optical connection lines 64. Additionally, some of the traditional gaming devices 70, 71, and 75 may include electronic gaming tables, multi-station gaming devices, or electronic components operating in conjunction with non-gaming components, such as automatic card readers, chip readers, and chip counters, for example.

Gaming devices 71 coupled over an optical line 64 may be remote gaming devices in a different location or casino. The optical line 64 may be coupled to the gaming network 50 through an electronic to optical signal converter 63 and may be coupled to the gaming devices 71 through an optical to electronic signal converter 65. The banks of gaming devices 70 coupled to the network 50 may be coupled through a bank controller 60 for compatibility purposes, for local organization and control, or for signal buffering purposes. The network 50 may include serial or parallel signal transmission lines and carry data in accordance with data transfer protocols such as Ethernet transmission lines, Rs-232 lines, firewire lines, USB lines, or other communication protocols. Although not shown in FIG. 3, substantially the entire network 50 may be made of fiber optic lines or may be a wireless network utilizing a wireless protocol such as IEEE 802.11 a, b, g, or n, Zigbee, RF protocols, optical transmission, near-field transmission, or the like.

As mentioned above, each gaming device 70-75 may have an individual processor 40 (FIG. 1A) and memory 41 to run and control game play on the gaming device 70-75, or some of the gaming devices 70-75 may be terminals that are run by a remote server 80 in a server based gaming environment. Server based gaming environments may be advantageous to casinos by allowing fast downloading of particular game types or themes based on casino preference or player selection. Additionally, tournament based games, linked games, and certain game types, such as BINGO or keno may benefit from at least some server 80 based control.

Thus, in some embodiments, the network 50, server 80, and database 90 may be dedicated to communications regarding specific game or tournament play. In other embodiments, however, the network 50, server 80, and database 90 may be part of a player tracking network. For player tracking capabilities, when a player inserts a player tracking card in the card reader 46 (FIG. 1A), the player tracking unit 45 sends player identification information obtained on the card reader 46 through the MCI 42 over the network 50 to the player tracking server 80, where the player identification information is compared to player information records in the player database 90 to provide the player with information regarding their player account or other features at the gaming device 10 where the player is wagering. Additionally, multiple databases 90 and/or servers 80 may be present and coupled to one or more networks 50 to provide a variety of gaming services, such as both game/tournament data and player tracking data.

The various systems described with reference to FIGS. 1-3 can be used in a number of ways. For instance, the systems can be used to track data about various players. The tracked data can be used by the casino to provide additional benefits to players, such as extra bonuses or extra benefits such as bonus games and other benefits as described above. These added benefits further entice the players to play at the casino that provides the benefits.

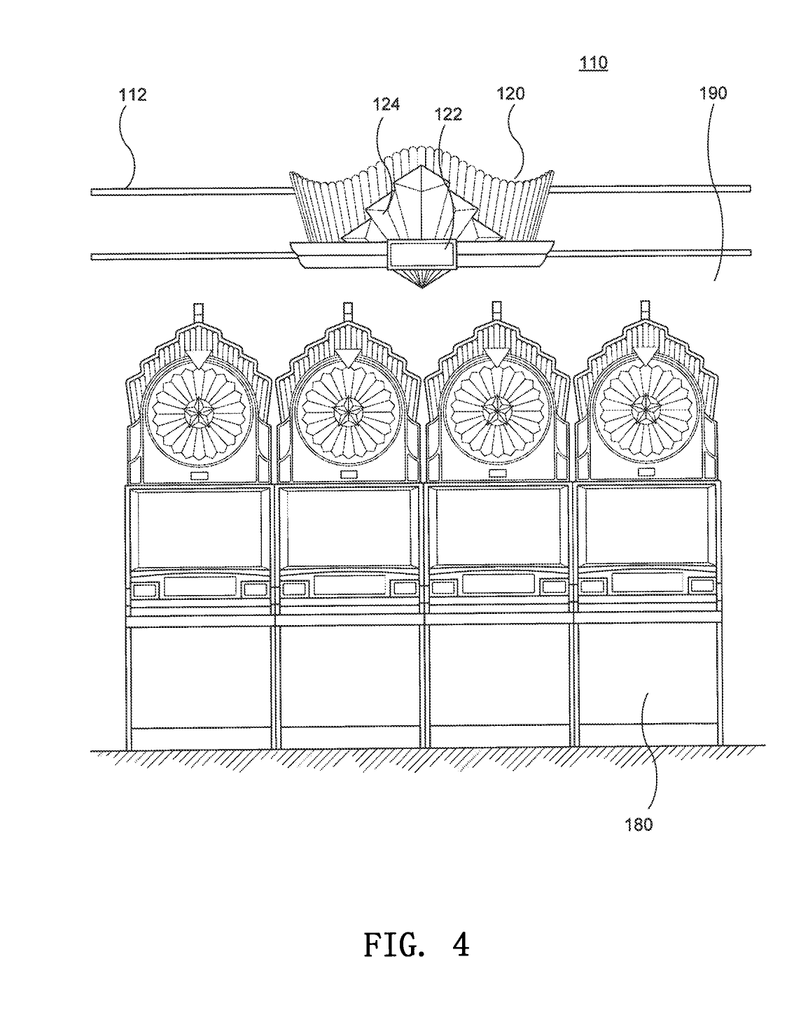

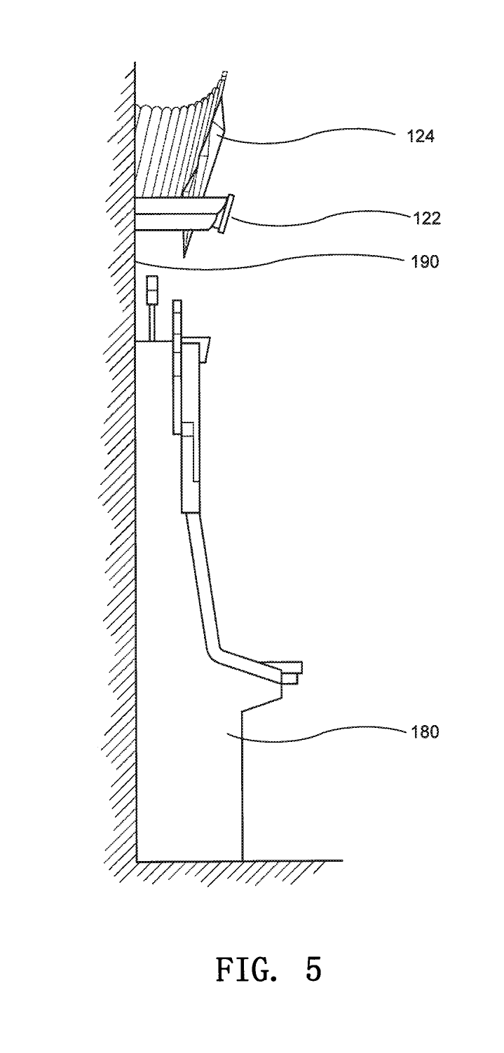

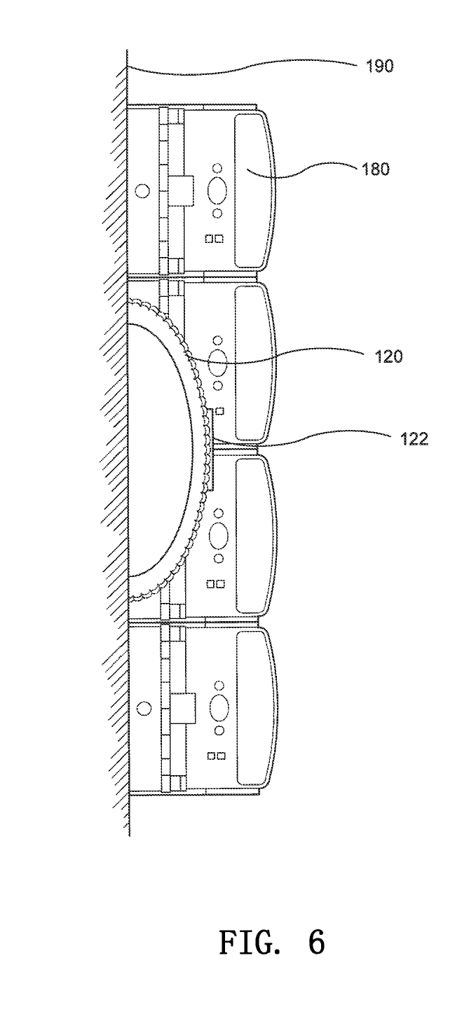

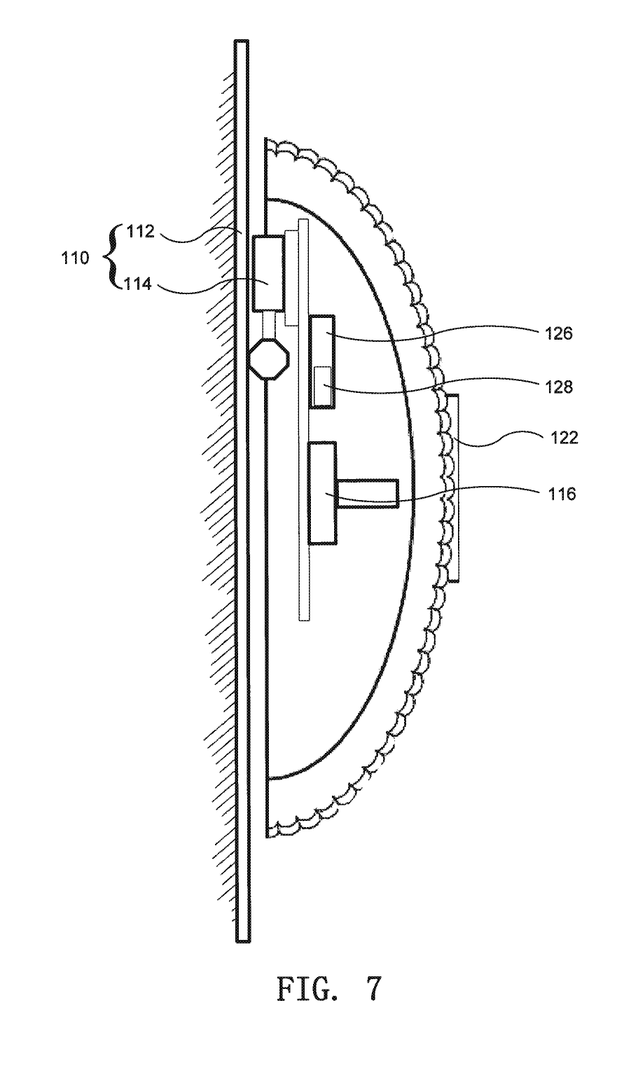

FIGS. 4-7 illustrate a moving indicator in accordance with some embodiments of the invention. FIG. 4 is a front view of a moving indicator positioned above a bank of gaming devices. FIG. 5 is a side view of the moving indicator. FIG. 6 is a top view of the moving indicator. FIG. 7 is a schematic view of the moving indicator illustrating various components.

Referring to FIGS. 4-7, a moving indicator 100 includes a moving unit 110 and at least one moveable platform 120. The moving unit 110 can include one or more tracks 112 and a motor 114. The tracks 112 can be any type of track capable of supporting the moveable platform 120 and allowing movement of the moveable platform 120 in two or more directions. The tracks 112 can be rigidly mounted to a wall 190. Although only two tracks 112 are shown in FIG. 4, any number of tracks 112 can be used. Further, although the tracks 112 shown in FIG. 4 only allow horizontal movement in two directions, the tracks 112 can be configured to allow movement in any direction by, for example, including two or more track paths, each of the paths allowing movement in a different direction.

The moving unit 110 can also include a first set of tracks rigidly mounted on the wall 190 and a second set of tracks movably mounted on the first set of tracks. In this case, the first set of tracks may allow substantially horizontal movement of the moveable platform 120 along the wall 190 and the second set of tracks may allow substantially vertical movement of the moveable platform 120 along the wall 190. The moving unit 100 may also include an extender 116. The extender 116 may move the moveable platform 120 (or a portion of the moveable platform 120) away from the wall 190 (for example, in a direction normal to the wall 190).

The moveable platform 120 can include a display 122, a plurality of selectable features 124, and a controller 126. The display 122 can display numbers or letters as determined by the controller 126. The display 122 may be any of a liquid-crystal display, a light-emitting diode display, and the like. The selectable features 124 can include lights, sounds, and moveable elements and each of the selectable features 124 may have one or more modes of operation. For example, a light selectable feature may have an off mode, a red mode, and a blue mode. As a further example, a sound selectable feature may have an off mode, a rapid beat mode, and a slow beat mode. The modes of the various selectable features 124 may be organized into themes. For example, the moving indicator 100 may have an idle theme, in which the modes of the selectable features 124 are set to minimize the attention drawn to the moving indicator 100, and a winner theme, in which the modes of the selectable features 124 are set to maximize the attention drawn to the moving indicator 100. A person or ordinary skill in the art will appreciate that these are just a small sample of the many possible themes that can be used with the moving indicator 100. The selection and activation of themes, modes, and selectable features can be performed by the controller 126.

The moveable elements can be configured such that, when activated, the moveable elements move to form a specific shape or to reveal a hidden element that was not previously visible on the moveable platform 120. As an example, the moveable elements may include a plurality of panels that, when activated, move apart from each other to expose a spot light, which subsequently shines a light in the vicinity of a specific gaming device or on the specific gaming device. As a further example, the hidden element could be a glitter ball that extends from the moveable platform to reflect light in multiple directions around the specific gaming device. The hidden element can also be a camera configured to emerge from the moveable platform 120 and take a souvenir photograph of the player's winning moment.

In addition to controlling the selectable features 124 and the display 122, the controller 126 can also control the movement of the moveable platform 120. For instance, the controller 126 can direct the motor 114 to activate and move the moveable platform 120 along the tracks 112.

The controller 126 may include a network adapter 128. The network adapter 128 can be a wireless network adapter or any type of standard wired network adapter. The network adapter 128 may allow the controller 126 to communicate with the gaming server 80. Alternatively, the network adapter 128 may allow the controller 126 to communicate with individual gaming devices in a bank of gaming devices 180. The communications received through the network adapter 128 may allow the controller 126 to determine where to move the moveable platform 120 and when to initiate the selectable features 124. Alternatively, the decision of how and when to activate the various aspects of the moving indicator 100 may be made at the gaming server 80 and the gaming server 80 may just direct the controller 126 to act accordingly.

The various movements, displays, lights, and sounds of the moving indicator 100 can be configured to coincide with events on the individual gaming devices of the bank of gaming devices 180. According to some embodiments, the moving indicator 180 is configured to be active when a player on one of the individual gaming devices gets a bonus. For example, during the course of a gaming session, a player may win a bonus that allows the player to initiate a bonus session on an auxiliary portion of the gaming device. The moving indicator 100 may then move into position above the individual gaming device and initiate a specific theme, for example, a bonus theme. The bonus theme may include flashing lights, unique sounds, messages on the display, and specific movements of the moveable elements in the moving indicator 100. Next, the player initiates the bonus session by pressing a button on the gaming device. The moving indicator 100 may respond by initiating a different theme or it may continue to perform the bonus theme. At the end of the bonus session, the player may receive a win amount. At this point, the moving indicator 100 may switch to a different theme, for example, a jackpot theme. The jackpot theme may include displaying the win amount in the display 122. The jackpot theme may run for a predetermined time after the end of the bonus session. At the end of the predetermined time, the moving indicator 100 may switch to a standby theme until a player wins a bonus on another one of the individual gaming devices.

According to other embodiments, the moving indicator 180 is configured to operate as a win proximity indicator. Win proximity indicators are described in U.S. patent application Ser. Nos. 12/037,295 and 12/037,206, which are hereby incorporated by reference in their entireties. As an example of how the moving indicator 100 can be used as a win proximity indicator, a plurality of players may be initiating gaming sessions on the individual gaming devices in a bank of gaming devices. Each of the players will be within a specific proximity of initiating a bonus session based on, for example, the length of time played and the number of credits played. The moving indicator 100 may move to a position above the gaming device on which the player in closest proximity to a bonus session is playing. As players come and go from the bank of gaming devices, the moving indicator 100 may move from gaming device to gaming device indicating which one is in the closest proximity to a bonus session. An individual gaming device above which the moving indicator 100 is positioned can be referred to as a linked gaming device because the operation of the moving indicator 100 is linked to the results of gaming sessions on the gaming device. According to the present embodiment, the moving indicator 100 is only linked to a single gaming device at any one time, but a person of ordinary skill in the art will appreciate that the moving indicator 100 could be linked to more than one gaming device.

As a player initiates successive gaming sessions on the linked gaming device, the proximity to a bonus session can increase correspondingly. The moving indicator 100 can be placed in an escalating theme. In the escalating theme, the selectable features 124 may change so as to correspond to the proximity. For example, lights on the moving indicator 120 may start out blue when the proximity is low and transition to red as the proximity becomes high. As another example, lights on the periphery of the moving indicator 100 may be lit when the proximity is low and, as the proximity increases, lights nearer to the center of the moving indicator 100 light up in a progressive fashion. Once the bonus session is achieved, the moving indicator 100 may respond as described above in the previous embodiment.

The moving indicator 100 can respond to other conditions as well. For example, during times of under-utilization of gaming devices, the moving indicator 100 can be positioned over a particular gaming device in a bank of gaming devices, where the particular gaming device is tied to a particular desirable result from a player's perspective. For instance, the particular gaming device may have the highest likelihood of a substantial payout in the fewest number of gaming sessions. Alternatively, the particular gaming device may be the gaming device that has gone the longest without a substantial payout. A person of ordinary skill in the art will appreciate that there are many other possible conditions upon which the positioning of the moving indicator 100 can be based.

The moving indicator 100 can include more than one moveable platform 120. In the case of two moveable platforms 120, the two moveable platforms 120 can be used as win proximity indicators. For example, the two moveable platforms 120 can be positioned respectively over two gaming devices in which players are within some proximity of a bonus. Each of the two moveable platforms 120 can then operate as described above. Due to the presence of the moveable platforms 120, the two players may begin to compete to see who can be the first to achieve the bonus. Thus, the excitement of the gaming session may be increased for the two players involved, as well as passers-by. The two moveable platforms 120 may be associated with the same set of tracks or they may run on different tracks and each of the moveable platforms 120 may have a separate motor 114. The two moveable platforms 120 may be configured such that they can combine to form a single moveable platform 120 when a ‘single mode’ is desired and split apart into two moveable platforms 120 when a ‘dual mode’ is desired. The selection of whether the single mode or dual mode is active can be based on the time of day, the amount of activity in the casino, the identities of the two players (as determined by the player tracking system), or any other factor. A person of ordinary skill in the art will appreciate that any number of moveable platforms 120 may be used.

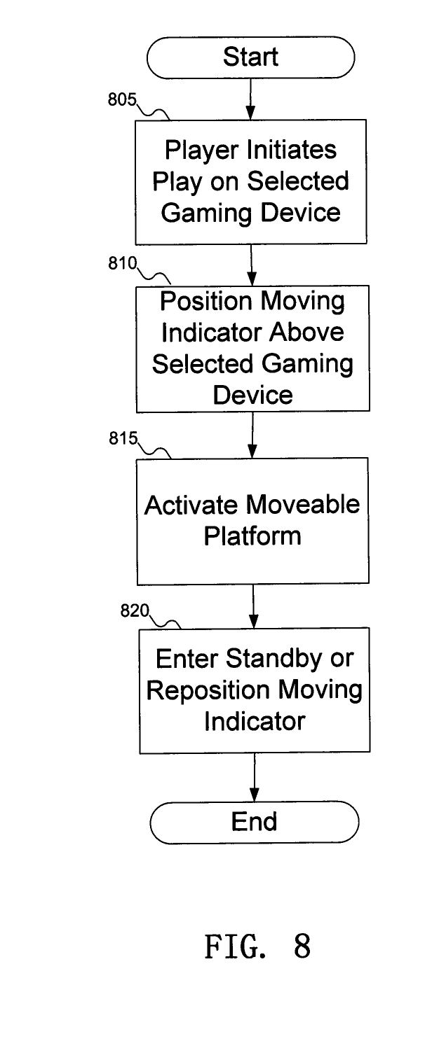

FIG. 8 is a flowchart of a method of operating a moving indicator.

Referring to FIG. 8, at step 805, a player initiates play on a selected gaming device among a bank of gaming devices. At step 810, a moving indicator is positioned above the selected gaming device. The moving indicator can be positioned in response to communications received over a network at the moving indicator from either a gaming server or the bank of gaming devices. At step 815, a moveable platform on the moving indicator is activated. Activating the moveable platform can include activating a display, one or more lights, one or more sounds, and/or one or more moveable elements. Activating the moveable platform can further include activating the moveable elements so as to expose a hidden element within the moveable platform. Activating the moveable platform can also include displaying a win amount in the display. Communications received over the network can cause the moveable platform to activate. For example, the moveable platform may display a certain theme in response to a win proximity indication received over the network. Finally, activating the moveable platform can include splitting the moveable platform into at least two individual moveable platforms and moving each of the individual moveable platforms above a respective one of the gaming devices in the bank of gaming devices. Each of the individual moveable platforms can then respond to events on the respective gaming devices. Activating the moveable platform may include activating successive themes or repeating the same theme until it is no longer desirable for the moving indicator to be linked to events on the gaming device. At step 820, the moving indicator can either enter a standby state in which it is no longer linked to events on the selected gaming device or it can reposition over another one of the gaming devices.

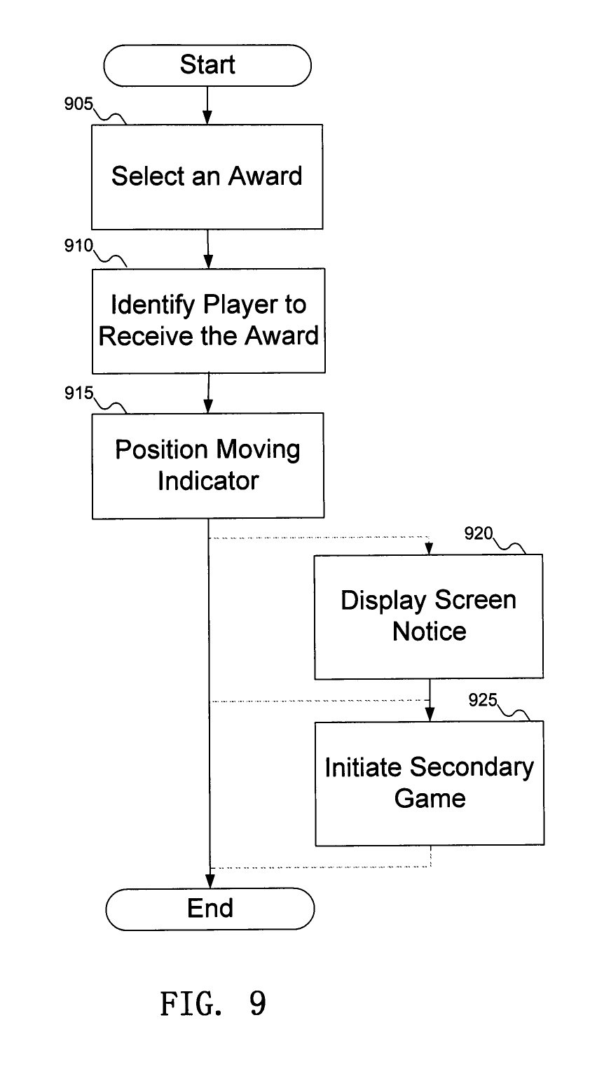

FIG. 9 is a flowchart of a method of conducting a game of chance.

Referring to FIG. 9, at step 905, an award is selected. The award can be any type of award associated with a gaming session. For example, the award could be a bonus, a secondary game, a win, a progressive award, and/or a mystery award. At step 910, a player is identified to receive the award. The player can be one among several players participating in gaming sessions on a bank of gaming devices. The player can be identified based on an event on the particular gaming device associated with the player. Also, the player can be identified based on player tracking data associated with the player. At step 915, a moving indicator is positioned above one or more gaming devices in a bank of gaming devices. The moving indicator can be positioned above the gaming device associated with the identified player. As described above, the moving indicator can also split into multiple moving platforms that can be positioned above multiple players. In other words, multiple players can be selected to receive the award and the moving indicator (or portions of the moving indicator) can be positioned above each of the players.

The moving indicator can be maintained in a static or idle position when no players have been selected for an award. When in the static or idle position, the moving indicator may be turned off or it may run a static theme. Alternatively, the moving indicator may be maintained in a standby mode when no players have been selected for an award. In the standby mode, the moving indicator may move above the bank of gaming devices according to a pre-determined pattern and may run a standby theme. When the moving indicator is maintained in the standby mode, the positioning of the moving indicator can include stopping the moving indicator above the gaming device associated with the selected player.

The movement of the moving indicator may be responsive to a game dictated event such as a win event or a bonus game initiation. Alternatively, the movement of the moving indicator can be responsive to a player dictated event. The player dictated event can be, for example, the selection of a color or theme for the moving indicator, selecting a sound for the moving indicator, the player requesting repositioning of the moving indicator, selecting an unlockable feature, and/or achieving a pre-determined number of player points. In other words, the player may dictate the movement of the moving indicator through the player's associated gaming device. The player may get the option to dictate the movement of the moving indicator as a reward based on player tracking data and/or statistics from the player's current gaming session. When the player obtains such a reward, the player can be prompted to either dictate the movement of the moving indicator or to disregard the reward.

At alternate step 920, the gaming device associated with the player selected for the award can display a screen notice. The screen notice can prompt the player to look at the moving indicator. The screen notice can also prompt the player to select one of a list of themes to run while above the gaming device associated with the selected player.

At alternate step 925, a secondary game can be initiated on the gaming device associated with the selected player. The secondary game can be initiated after the moving indicator is positioned above the gaming device or while the moving indicator is being positioned. A first theme can be activated on the moving indicator when the secondary game is initiated. Also, a second theme can be activated on the moving indicator at the conclusion of the secondary game. The second theme can depend on the outcome of the secondary game.

Although described above as being mounted on a wall, a person of ordinary skill in the art will appreciate that the moving indicator 100 may be mounted to a floor, to a ceiling, or it may be freestanding with a frame to provide structural support for the tracks. Further, although the tracks have been shown as protruding from the wall, the tracks may be recessed within the wall and the tracks may be any type of suitable device, including rails, sliders, and the like.

Some embodiments of the invention have been described above, and in addition, some specific details are shown for purposes of illustrating the inventive principles. However, numerous other arrangements may be devised in accordance with the inventive principles of this patent disclosure. Further, well known processes have not been described in detail in order not to obscure the invention. Thus, while the invention is described in conjunction with the specific embodiments illustrated in the drawings, it is not limited to these embodiments or drawings. Rather, the invention is intended to cover alternatives, modifications, and equivalents that come within the scope and spirit of the inventive principles set out in the appended claims.

1. A moving indicator, comprising:
a moving unit; and
at least one moveable platform coupled to the moving unit, wherein the moving unit is configured to position the moveable platform above a selected gaming device among a bank of gaming devices.

2. The moving indicator of claim 1, wherein the moving unit comprises:
at least one track mounted on a wall; and
a motor configured to move the moveable platform along the at least one track.

3. The moving indicator of claim 1, wherein the moveable platform comprises:
a display;
a plurality of selectable features; and
a controller configured to control movement of the moveable platform and to activate the selectable features.

4. The moving indicator of claim 3, wherein the moveable platform further comprises an extender configured to move at least a portion of the moveable platform in an outward direction.

5. The moving indicator of claim 3, wherein the controller comprises a network adapter configured to communicate with at least one of a gaming server and the bank of gaming devices.

6. The moving indicator of claim 5, wherein the network adapter comprises a wireless network adapter.

7. The moving indicator of claim 3, wherein the selectable features include at least one of a light, a sound, and a moveable element.

8. The moving indicator of claim 7, wherein the moveable element is configured to expose a hidden element within the moveable platform.

9. The moving indicator of claim 1, wherein the moveable platform is configured to separate into at least two moveable platforms.

10. A method of operating a selected gaming device among a bank of gaming devices, comprising:
positioning a moving indicator above the selected gaming device, the moving indicator including a moving unit and a moveable platform; and
activating the moveable platform in response to an event associated with the selected gaming device.

11. The method of claim 10, wherein positioning the moving indicator includes moving the moveable platform along at least one track, the track extending above the bank of gaming devices.

12. The method of claim 10, wherein activating the moveable platform includes activating at least one of a display, a light, a sound, and a moveable element.

13. The method of claim 12, wherein activating the moveable platform further includes activating the moveable element so as to expose a hidden element within the moveable platform.

14. The method of claim 12, wherein activating the moveable platform further includes displaying a win amount in the display.

15. The method of claim 10, further comprising receiving communications through a network adapter in the moveable platform from at least one of a gaming server and the bank of gaming devices, and wherein positioning the moving indicator includes moving the moveable platform responsive to the communications.

16. The method of claim 15, wherein activating the moveable platform comprises activating the moveable platform responsive to the communications.

17. The method of claim 16, wherein activating the moveable platform comprises activating the moveable platform responsive to a win proximity indication in the communications.

18. The method of claim 10, wherein positioning the moving indicator comprises:
splitting the moveable platform into at least two individual moveable platforms; and
moving each of the individual moveable platforms above a respective one of the gaming devices in the bank of gaming devices.

19. A method of conducting a game of chance, comprising;
selecting an award;
identifying a player to receive the award; and
positioning a moving indicator disposed above one or more gaming devices to a position above a gaming device associated with the player responsive to the identifying.

20. The method of claim 19, further comprising providing a screen notice on a display of the gaming device associated with the player.

21. The method of claim 20, further comprising prompting the payer to look at the moving indicator.

22. The method of claim 19, wherein positioning the moving indicator comprises moving the moving indicator from a static position.

23. The method of claim 19, further comprising moving the moving indicator above the one or more gaming devices prior to identifying the player.

24. The method of claim 23, wherein moving the moving indicator above the one or more gaming devices comprises moving the moving indicator responsive to a game dictated event.

25. The method of claim 23, wherein moving the moving indicator above the one or more gaming devices comprises moving the moving indicator responsive to a player dictated event.

26. The method of claim 25, wherein the player dictated event comprises at least one of selecting a color, selecting a theme, and selecting a sound.

27. The method of claim 19, wherein the award comprises a secondary game award.

28. The method of claim 27, further comprising initiating a secondary game on the gaming device associated with the player after positioning the moving indicator.

29. The method of claim 28, further comprising activating a theme on the moving indicator at the completion of the secondary game.

30. A gaming system, comprising:
a bank of gaming devices including a plurality of individual gaming devices;
a gaming server;
a moving indicator; and
a network connecting the gaming server to the moving indicator and the bank of gaming devices,
wherein the moving indicator includes a moving unit and a moveable platform and wherein the moving unit is configured to position the moveable platform above at least one of the individual gaming devices.

31. The system of claim 30, wherein the moving unit comprises:
at least one track mounted on a wall; and
a motor configured to move the moveable platform along the at least one track.

32. The system of claim 30, wherein the moveable platform comprises:
a display;
a plurality of selectable features; and
a controller configured to control movement of the moveable platform and to activate the selectable features and the display.

33. The system of claim 32, wherein the moveable platform further comprises an extender configured to move at least a portion of the moveable platform in an outward direction.

34. The system of claim 32, wherein the selectable features include at least one of a light, a sound, and a moveable element.

35. The system of claim 34, wherein the moveable element is configured to expose a hidden element within the moveable platform.

36. The system of claim 32, wherein the display is configured to display a win amount associated with the at least one of the individual gaming devices.

37. The system of claim 30, wherein the moveable platform is configured to separate into at least two individual moveable platforms.

38. The system of claim 30, wherein the network comprises a wireless network.

39. A gaming system, comprising:
a moving indicator configured to identify a win on at least one gaming device associated with the moving indicator; and
a moving unit configured to position the moving indicator above the at least one gaming device responsive to the win.

40. The gaming system of claim 39, further comprising a screen on the at least one gaming device configured to provide a screen notice of the win.

41. The gaming system of claim 40, wherein the screen notice comprises a prompt to look at the moving indicator.

42. The gaming system of claim 39, wherein the moving indicator is further configured to remain static until the win is identified.

43. The gaming system of claim 39, wherein the moving unit is further configured to travel during gaming sessions before the win.

44. The gaming system of claim 39, wherein the moving unit is further configured to move the moving indicator in response to a game dictated event.

45. The gaming system of claim 39, wherein the moving unit is further configured to move the moving indicator in response to a player dictated event.

46. The gaming system of claim 45, wherein the player dictated event comprises at least one of selecting an unlockable feature, achieving a pre-determined number of points, selecting a color, selecting a theme, and selecting a sound.
